(19) United States
(12) Patent Application Publication
(10) Pub. No.: US 2007/0117734 A1
(43) Pub. Date: May 24, 2007

(54) Liquid-crystalline washing or cleaning composition containing a particulate bleaching agent

(76) Inventors: Hermann Jonke, Dusseldorf (DE); Johannes Zipfel, Hilden (DE); Helga Werner, Rommerskirchen (DE); Horst-Dieter Speckmann, Langenfeld (DE); Sabine Schumann, Neuss (DE)

Correspondence Address: PAUL & PAUL, 2000 MARKET STREET, PHILADELPHIA, PA, 19103-3229, US

(21) Appl. No.: 11/543,740

(22) Filed: Oct. 5, 2006

Related U.S. Application Data
(63) Continuation of application No. PCT/EP05/03705, filed on Apr. 8, 2005.

(30) Foreign Application Priority Data
Apr. 16, 2004 (DE) 10 2004 019 139.5

(51) Int. Cl. C11D 3/395

(52) U.S. Cl. 510/302

(57) ABSTRACT

A liquid washing or cleaning agent, which comprises a bleaching agent, a limited amount of water, and a particulate peroxycarboxylic acid, and which forms a lamellar liquid-crystalline phase without the introduction of water. The agent may be in the form of a water-soluble portion comprising the agent.

### CROSS-REFERENCE TO RELATED APPLICATIONS.

This application is a continuation under 35 U.S.C. § 365(c) and 35 U.S.C. § 120 of International Application No. PCT/EP2005/003705, filed Apr. 8, 2005, which is incorporated herein by reference in its entirety. This application also claims priority under 35 U.S.C. § 119 of German Application No. DE 10 2004 019 139.5, filed Apr. 16, 2004. Both the International Application and the German Application are incorporated herein in their entireties.

### STATEMENT REGARDING FEDERALLY SPONSORED RESEARCH OR DEVELOPMENT.

Not Applicable

### INCORPORATION-BY-REFERENCE OF MATERIAL SUBMITTED ON A COMPACT DISC.

Not Applicable

### BACKGROUND OF THE INVENTION

(1) Field of the Invention

The present patent application relates to structured liquid detergents or cleansing compositions that comprise peroxycarboxylic acids.

In liquid detergent and cleansing compositions, particularly when they comprise water, but also when they are anhydrous, there may result a decrease in their activity and thereby a decrease in the overall washing performance of the composition because of interactions between the individual ingredients due to chemical incompatibility, even when the composition is stored for a relatively short time. In principle, this decrease in activity concerns all detergent ingredients that in the washing process undergo chemical reactions that contribute to the washing performance, particularly bleaching agents and enzymes, although also tensidic or chelating ingredients that are responsible for dissolution processes or complexation steps are not completely storage stable in liquid, particularly aqueous systems, particularly in the presence of the cited chemically reactive ingredients.

On various occasions, it has been proposed to solve this problem by not simultaneously incorporating all ingredients required for a good washing or cleaning result into a liquid composition, but rather by supplying the consumer with several components that have to be mixed together shortly before, or during the washing or cleaning process and which each only comprise ingredients that are compatible with each other and first come into contact together during the course of the application. The combined dosing of several components, in comparison with dosing only a single liquid composition, is often felt by the consumer as being too laborious.

Imidoperoxycarboxylic acids are known bleach ingredients in detergents and cleansing compositions. However, their poor storage stability is problematic, especially in liquid formulations and at higher pH values. Proposals have already been made in the prior art to solve this problem.

In European Patent Application EP 0 510 761 A1, particles of 6-phthalimidoperoxyhexanoic acid are described, which are encapsulated with a layer of wax with a melting point in the range 40° C. to 50° C. The bleaching agent can therefore only be released from these particles at temperatures above the melting point of the wax.

European Patent Application EP 0 653 485 discloses capsule compositions, in the interior of which, 6-phthalimidoperoxyhexanoic acid is present as a dispersion in oil.

Moreover, the result of the measures described in the prior art for stabilizing bleaching agents, particularly in liquid compositions, is not always sufficient. For long storage times, the bleaching agent has been observed to decompose —in spite of the presence of the cited stabilizers —with a consequent loss in bleach activity and thus in washing power.

In response to the consumers'wish for easy dosing, pre-portioned products have also established themselves in the market and are also extensively described in the prior art. Detergents, cleansing compositions or care products in the form of molded objects have been described, i.e. tablets, blocks, briquettes, rings and the like, as well as portions of solid and/or liquid detergents, cleansing compositions or care products packaged in film sachets.

In the case of the single-dose quantities of detergent or cleansing compositions packaged in film sachets, which reached the market, film sachets made of water-soluble film prevailed. They do not require the consumer to tear open the packaging. Detergents or cleansing compositions packaged in this way as individual dosage units can be easily dosed by introducing one or more sachets directly into the washing machine or automatic dishwasher, especially into their dispensing draw, or by throwing the sachet into a defined amount of water, for example, in a bucket, a bowl or in a wash basin or rinsing basin. The film sachet surrounding the detergent, cleansing composition or care product portion dissolves on reaching a defined temperature, without leaving a residue. Detergents and cleansing compositions packaged in water-soluble film sachets have also been extensively described in the prior art. Thus, German Patent Application DE 198 31 703 discloses a portioned detergent or cleansing preparation in a sachet made of water-soluble film, in particular in a sachet made from (optionally acetalized) polyvinyl alcohol (PVAL), in which at least 70 wt. % of the particles of the detergent or cleaning composition preparation have a particle size greater than 800 μm.

Processes for manufacturing water-soluble capsules of polyvinyl alcohol or gelatin are known in the prior art, which in principle offers the possibility of providing capsules with a high filling potential. The processes are based on introducing the water-soluble polymer into a mold. The capsules are filled and sealed either synchronously or in consecutive steps, wherein in the latter case they are filled through a small opening. Processes, in which the filling and sealing run in parallel, are described, for example, in WO 97/35537. The capsules are filled by means of a filling reservoir, located above two counter-rotating drums that have hemispherical indentations on their surface. The drums supply polymer tapes that cover the hemispherical cavities. The sealing occurs at the positions where the polymer tape from one drum meets the polymer tape of the opposing drum. In parallel, the filling material is injected into the capsule being formed, wherein the injection pressure of the filling liquid presses the polymer tapes into the hemispherical cavities.

A process for manufacturing water-soluble capsules, in which first the filling and then the sealing occurs, is disclosed in International Patent Application WO 01/64421. The production process is based on the so-called Bottle-Pack® process, as is described, for example, in German Patent Application DE 14 114 69. Here, a tubular preform is fed into a two-part cavity. The cavity is closed, thereby sealing the lower part of the tube; the tube is then blown up to form the shape of the capsule in the cavity, filled and finally sealed.

In a first subject matter, with which is solved the problem of the stability of peroxycarboxylic acids in liquid compositions, the invention relates to a bleach-containing liquid detergent or cleansing composition that has a low water content and comprises a particulate peroxycarboxylic acid and forms a lamellar liquid crystalline phase without water ingress.

The term “low water content” is understood to mean a composition that comprises more than 0 wt. %, particularly at least 1 wt. %, but not more than 10 wt. %, in particular not more than 5 wt. % water.

The feature “without water ingress” in relation to the lamellar liquid crystalline phase, is intended to mean that directly after production of the composition and on storage under total exclusion of external sources of water, a lamellar liquid-crystalline phase exists and also remains. On the ingress of water from the surrounding air, which under real storage conditions, for example, can already diffuse through the packaging material, the lamellar liquid-crystalline phase admittedly must not inevitably remain for an unlimited time. Rather, it can at least partially transform into a hexagonal phase that in some cases even leads to an improved stability of the peroxycarboxylic acid.

Lamellar liquid-crystalline compositions are known in the prior art. The inventive composition is obtained by at least partial substitution of the quantity of water used for their production by an aqueous composition, for example, a dispersion, that comprises the peroxycarboxylic acid.

An inventive composition preferably comprises 20 wt. % to 50 wt. % ether sulfate, 20 wt. % to 50 wt. % room temperature liquid hydrocarbon, particularly paraffin oil, and up to 50 wt. % C₁₂-C₁₈ fatty alcohol, particularly stearyl alcohol, besides up to 10 wt. %, particularly 1 wt. % to 10 wt. % water. The cited quantities of water are preferably incorporated in a simple way into the composition by the use of commercial water-containing qualities of the various cited ingredients. If required, the water fraction or part of it, preferably up to half of the amount, can be substituted by lower alcohols, for example, methanol, propanol, glycerin and preferably ethanol.

An ether sulfate is understood to mean the alkali salts and ammonium salts of the sulfuric acid mono-esters derived from straight-chained or branched C₇₋₂₁ alcohols ethoxylated with 1 to 6 moles ethylene oxide, such as 2-methyl-branched C₉₋₁₁ alcohols with an average of 3.5 mol ethylene oxide (EO) or C₁₂₋₁₈ fatty alcohols with 1 to 4 EO.

If required, inventive compositions can also comprise further ingredients, particularly colorants, fragrances, enzymes and/or optical brighteners, through which the lamellar liquid-crystalline phase is not unacceptably impaired.

It is important that the inventive compositions comprise a particulate peroxycarboxylic acid. Preferably, the peroxycarboxylic acid has a water solubility in the range 50 to 800 ppm. The use of 6-phthalimidoperoxyhexanoic acid is preferred. 6-Phthalimidoperoxyhexanoic acid is known, for example, from the European patents EP 0 349 940 and EP 0 325 328. Its use in liquid detergents or cleansing compositions is known, for example, from European Patent Applications EP 0 442 549, EP 0 477 190, EP 0484 095 or EP 1 010 750 or International Patent Applications WO 00/27960, WO 00/27971 or WO 00/29536. Preferably, the peroxycarboxylic acid is in finely divided form, particularly with average diameters below 100 μm. Grinding processes that enable such particle sizes to be obtained are disclosed, for example, in International Patent Application WO 00/27969 or German Patent Application DE 102 59 262.

Inventive compositions can be filled in the normal way into containers designed for liquid detergents or cleansing compositions, for example, canisters or bottles, and dosed out from these by the consumer. However, for the reasons described above, simpler dosing, they are preferably offered in suitably packaged portions made of water-soluble material.

Accordingly, a preferred further subject matter of the invention is a water-soluble portion, comprising a, as described, composition composed according to the invention and manufactured according to a process including the steps
(a) preparation of at least one cavity,
(b) inserting a water-soluble thermoplastic polymer into the cavity,
(c) filling the cavity/cavities that are filled with the thermoplastic with the agent and
(d) sealing the portion resulting from the steps (a) to (c).

A preferred process for manufacturing the water-soluble portions is the Rotary-Die process, as is described, for example, in WO 97/35537 for the manufacture of water-soluble capsules. The water-soluble portions are manufactured by locally injecting the liquid agent with a dosing device by means of a filling key between two tapes made of water-soluble thermoplastic polymer that are located on two shaping cylinders that rotate parallel to one another and which have molds running around the circumference of their outer surfaces, whose shape corresponds to each half of a portion being manufactured. The sealing is effected by contact pressure on both the film tapes. In a preferred embodiment, in order to improve the sealing, at least one of the water-soluble film tapes is solvated with a solvent prior to the process for molding the object. In addition, heat sealing both the portion halves is preferred. For this, both the shaping cylinders can advantageously serve as electrodes for the dielectric sealing of the films to each other. To facilitate the liquid injection in the molding process, a vacuum can be advantageously applied to the cavities. This allows the liquid injection pressure to be reduced and therefore the risk of contaminating the polymer with liquid filling material at the sealing positions is diminished. The shaping cylinders are advantageously roughened in the region of the cylinder walls. Roughening the cylinder walls increases the static friction for the films used to manufacture the portions.

Depending on the shape of the cavities in the molding cylinders, portions of any geometry with a reflection plane can be manufactured. Geometries like spheres, eggs, cubes, figures are preferred in the context of this invention.

The dosing device ensures that an exactly measured quantity of the liquid composition is injected into the water-soluble portions. It is particularly advantageous when the injection impact is followed by a return stroke of the dosing device. In this way, drops or strings of the composition, which once again can lead to a contamination of the water-soluble film in the sealing region, are avoided.

A further preferred process for manufacturing water-soluble portions is the blow molding process. Water soluble, flexible, preferably elastic, hollow articles that comprise compositions, particularly detergent, cleansing composition and/or care product portions, can be manufactured by blow molding. Like the Rotary-Die process, the blow molding process has substantial technical processing advantages in comparison to thermoforming and injection molding processes. The blow molding process and the Rotary-Die process are economical with materials because no pinch points or other residual or leftover parts need to be removed from the manufactured hollow articles.

The manufacture of a water-soluble portion comprising an inventive composition by blow molding includes the following steps:
(a) shaping a preform from a blow-molding compound based on a water-soluble thermoplastic polymer;
(b) blow molding the preform in a cavity to a hollow article;
(c) filling the hollow article with the composition and
(d) liquid-tight sealing the molded and filled portion.

Advantageously, the production is carried out in such a way that
(a) in a first step a preform is extruded, preferably in the shape of a piece of tubing, and
(b) in a second step in one working cycle, the hollow article is blown by means of a pressurized gas, preferably compressed air, preferably to the final shape of the hollow article (corresponding to the dimensions of the cavity) and filled with the composition, in particular a detergent, care product or cleansing composition, liquid-tight sealed, and finally ejected from the mold.

Suitable blow molding processes include extrusion blowing, coextrusion blowing, injection-stretch blowing and dip blowing.

The cavity can be built with multi-part moldings, but a two-part cavity is preferred. In a preferred embodiment, a blade, as described, for example, in WO 01/64421, is used to separate the preform and/or to seal the portions. The use of a vibrating cutting device, as explicitly disclosed in EP 0 924 047, is particularly preferred.

After filling, the filling opening of the hollow article can be additionally sealed, preferably by a material closure, preferably by means of thermal treatment, particularly preferably by depositing a splodge of melt.

The filling opening or openings of the hollow article can be advantageously sealed liquid-tight by thermal treatment, preferably by melting the walls adjacent to the opening, in particular by means of clamping jaws.

The inventive water-soluble filled portions manufactured by the blow molding process or Rotary-Die process have the following properties in advantageous embodiments, such that:
(a) elongated along the longest axis, the tensile stress at yield is between ≧3 N/mm² and ≦15 N/mm² and/or
(b) with a vertical central crush path of 22 mm along the shortest axis, a deformation force is between ≧0.05 Nm and ≦5 Nm, and/or
(c) is deformable with a force F₁>0.1 N and ≦500 N along a distance s₁ and after release of the force returns towards the original shape, and/or
(d) after release of a deformation force, a recovery rate v is between >0.01 mm/min and ≦650 mm/min, and/or
(e) the module of elasticity of the flexible portion of the wall of the hollow article produced by blow molding or by the Rotary-Die process, when filled at >90 vol. % is ≦1 GNm², preferably ≦0.1 GNm², particularly ≦0.01 GNm², and/or
(fi) for a 90 vol. % filled hollow article produced by blow molding or by the Rotary-Die process, the crush resistance Fₘₐₓ is between ≧20 N and ≦2,000 N.

The inventive portions dissolve or substantially dissolve in water, whereupon the compositions comprised in the closed, hollow article are released into the surroundings. For example, the water-soluble portions in accordance with the invention can be used in an automatic aqueous detergent, cleansing or care process. The use of the inventively manufactured hollow articles in commercial washing machines or automatic dishwashers is preferred. A use of the inventive portions in a sink or in a bowl is also possible. The external surrounding aqueous medium is important for the release of the composition comprised in the portion.

In preferred embodiments of the invention, the size of the hollow article is such that it can be introduced into the dispensing draw of a commercial washing machine or automatic dishwasher, along with the washing in netting or in sacks or the like. Particularly preferred embodiments of the inventive portions of detergent, cleansing composition or care product do not exceed a length (longest axis) of 10 cm, while the width and the height are significantly smaller, for example, 1 to 5 cm.

In the context of this invention, flexible hollow articles also especially include elastic hollow articles. The term “elastic hollow article” is especially understood to mean that the molded articles comprising the composition have their own dimensional stability that allows them, under normal conditions of manufacture, storage, transport and consumer utilization, to assume a non-collapsing structure that is stable against breakage and/or pressure, wherein the filled hollow article, manufactured by blow molding or by a Rotary-Die process, has a yield stress between ≧3 N/mm² and ≦15 N/mm² when elongated along its longest axis, and/or develops a deformation force between ≧0.05 Nm and ≦5 Nm against a vertical central crush path of 22 mm along the shortest axis, and/or is deformable with a force F₁>0.1 N and ≦500 N along a distance s₁ and after release of the force returns towards the original shape, or after release of the force, completely or almost completely adopts the original shape, and/or after release of the force, exhibits a recovery rate v between >0.01 mm/min and ≦650 mm/min, and/or the module of elasticity of the flexible portion of the wall of the hollow article produced by blow molding or by the Rotary-Die process, when filled at ≧90 vol. % is ≦1 GNm², preferably <0.1 GNm², particularly ≦0.01 GNm², and/or for a 90 vol. % filled hollow article produced by blow molding or by the Rotary-Die process, a crush resistance Fₘₐₓ between ≧20 N and ≦2,000 N exists. In preferred embodiments of the invention, the flexible, advantageously elastic hollow articles already possess an adequate dimensional stability of their own because this advantageously impacts their handling in machines during production of the hollow article and the filling during the production of the portions.

As mentioned above, the inventively manufactured portions should be preferably, at least partially reversibly deformable (for irreversible deformation there would be no measurable rate of recovery). In preferred embodiments of the present invention, the deformation is completely reversible, i.e. inventively portioned detergents, rinse compositions or cleansing compositions are preferred, in which the filled portion returns to its original shape after the deformation force has been removed.

The force F₁ is dependent on the indentation depth because the hollow article opposes the penetrating object with increasing resistance. Firstly, it is only necessary for the present invention that the hollow article can actually be deformed with a force of 500 N or less. In preferred embodiments of the present invention, the data relate to forces of the penetration depths of a circular rod with a diameter of 8 mm, particularly of 10 mm diameter, preferably of 15 mm diameter, preferably of 20 mm diameter and further preferably of 22 mm.

If the distance S₁ is defined, then not only the force but also the work of deformation can be exactly determined. For an applied force from a circular rod of 8 mm diameter and for a penetration depth of s₁=22 mm, the work of deformation for the flexible, filled hollow article manufactured by blow molding or Rotary-Die is significantly less than the values for comparable rigid, unfilled articles, for which a work of deformation of at least >5 Nm must be made.

An additional factor for characterizing the particularly preferred inventive portioned composition is the crush resistance. This can be determined in the form of a force displacement chart by means of commercial tablet testing instruments. A universal testing machine, type 1425 from Zwick, was used for the needs of the present invention.

The crush resistance was determined according to DIN 55526 part 1, in that the hollow article (=water-soluble portion) is placed upright between the plates of a pressure testing device and crushed, wherein the compressive force and the movement of the plates are recorded until the required crush resistance and plate movement are attained or failure of the container commences by critical deformation or leakage.

The compression press was adjusted to a crush speed of 10 mm/min. The test was then started. The force [N] exerted on the portion for a penetration depth of 22 mm was printed out on the connected printer. The crush resistance is given in N. Here, hollow articles with and without compartments comprising inventive, portioned compositions are preferred, wherein the crush resistance Fmax of the hollow articles comprising portioned composition (=the filled hollow article, with and without compartments) is 20 to 2,000 N, preferably 50 to 1,000 N, particularly preferably 75 to 600 N, further preferably 100 to 500 N and particularly 150 to 400 N. For the purposes of the test, the hollow article, manufactured by blow molding or the Rotary-Die process, is filled to ≧90 vol. %.

Different wall thicknesses according to the region of the hollow article can be produced by blow molding, whereby the wall thicknesses of the preform are made up, preferably along its vertical axis, of corresponding different thicknesses, preferably by regulating the amount of thermoplastic material, preferably by means of an adjustable spindle at the exit of the preform from the extruder die.

The hollow article can be blow molded with areas of different outer dimensions and constant wall thicknesses whereby the wall thicknesses of the preform are made up, preferably along its vertical axis, of corresponding different thicknesses, preferably by regulating the amount of thermoplastic material by means of an adjustable spindle at the exit of the preform from the extruder die.

In this manner, the different geometrical designs of the hollow article can be blow molded with and without compartments. In this way, bottles, spheres, Father Christmases, Easter rabbits or other figures can be blow molded, filled with product and then sealed and ejected in a single work step.

It is particularly advantageous that the hollow article can be embossed and/or decorated in the blow mold during blow molding. A mirror image of a motive can be transferred onto the hollow article by the corresponding design of the mold. In this manner, the surface of the hollow article can have practically any design. For example, information such as gauging lines, indications for use, danger symbols, trademarks, weight, quantities, end-use date, pictures etc., can be imprinted.

The preform, the hollow article and/or the liquid-tight sealed hollow article consists of one or more component(s), wherein the component includes one or more materials based on one or different water-soluble thermoplastic polymers.

The preform, the hollow article and/or the liquid-tight sealed hollow article can be tubular, spherical or vesicular. A spherical hollow article preferably has a shape factor of >0.8, preferably >0.82, more preferably >0.9 and particularly preferably >0.95.

In the sense of the present invention, the shape factor can be determined with precision by means of modern particle measurement techniques with digital image processing. A typical method, for example, is the Camsizer® system from Retsch Technology or the KeSizer® from the Kemira Company. These processes are based on the use of a light source to irradiate the hollow article or article, the acquisition of the projected surface of the article, which is digitalized and computer processed. The surface curvature is determined by an optical measurement technique, whereby the shadow, cast by the investigated parts, is measured and used to calculate the corresponding shape factor. The shape factor is measured based on the fundamental principle described for example, by Gordon Rittenhouse in “A visual method of estimating two-dimensional sphericity” in the Journal of Sedimentary Petrology, Vol. 13, Nr. 2, pages 79-81. The measurement limits for this optical analytical method are 15 μm to 90 mm. Methods for measuring the shape factor of larger particles are known to the person skilled in the art. Generally, they are based on the principles of the above-mentioned methods.

The walls of hollow articles made by blow molding or the Rotary-Die process normally have a wall thickness between 0.05 to 5 mm, preferably between 0,06 to 2 mm, more preferably between 0.07 to 1.5 mm, further preferably between 0.08 to 1.2 mm, even more preferably between 0.09 to 1 mm and most preferably between 0.1 to 0.6 mm.

The inventive portions have the type of wall thicknesses formed from water-soluble polymers, such that in general, the composition comprised in the portion is partially or totally released into the aqueous treatment liquor within ≦5 minutes, preferably within ≦3 minutes, more preferably within ≦1 minute.

To measure the release time, the portions were added to water with stirring at ≧60 rpm, wherein the water is held at 90° C., preferably at 60° C., further preferably at 40 ° C., even more preferably at 30° C. and particularly preferably at 20° C. More preferably, the release time is directly measured in the aqueous treatment liquor of at least one standard washing machine and/or automatic dishwasher.

The internal volumes of the inventive water-soluble portions can amount to between 0.5 ml and 2,000 ml, preferably between 2 ml and 500 ml, preferably between 5 and 250 ml, further preferably between 10 and 100 ml, even more preferably between 20 and 75 ml and most preferably between 40 and 50 ml.

The water-soluble thermoplastic polymer used to form the hollow article and/or the compartments is preferably selected from the group comprising polyvinyl alcohol (PVA), acetalized polyvinyl alcohol, polyvinyl pyrrolidone, polyethylene oxide, cellulose, starch and derivatives of these substances, polyvinyl alcohol (PVA), acetalized polyvinyl alcohol and/or mixtures of the cited polymers, wherein polyvinyl alcohol is particularly preferred.

The above-described polyvinyl alcohols are commercially available, for example, under the trade name Mowiol® (Clariant). Examples of polyvinyl alcohols which are particularly suitable in the context of the present invention are Mowiol® 3-83, Mowiol® 4-88, Mowiol® 5-88, Mowiol® 8-88 and Clariant L648.

Further polyvinyl alcohols that are particularly suitable as the material for the hollow article are to be found in the following table:

| | | | |
|---|---|---|---|
| | Hydrolysis | | Melting |
| Name | Degree [%] | Mol Wt [kDa] | point [° C.] |

| | | | |
|---|---|---|---|
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23.600 | 100 |
| Gohsefimer ® LL02 | 41-51 | 17.700 | 100 |

Further polyvinyl alcohols that are suitable as materials for the cavity are ELVANOL® 51-05, 52-22, 50-42, 85-82, 75-15, T-25, T-66, 90-50, (trade mark of Du Pont), ALCOTEX® 72.5, 78, B72, F80/40, F88/4, F88/26, F88/40, F88/47, (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade mark of Nippon Gohsei K. K.).

The water-soluble thermoplastic used to manufacture the inventive portion can comprise additional polymers, selected from the group comprising polymers containing acrylic acid, polyacrylamides, oxazoline polymers, polystyrene sulfonates, polyurethanes, polyesters, polyethers and/or mixtures of the above polymers.

Preferably, when the used water-soluble thermoplastic comprises a polyvinyl alcohol, the hydrolysis degree of the PVA is 70 to 100 mol %, preferably 80 to 90 mol %, particularly preferably 81 to 89 mol % and particularly 82 to 88 mol %.

Further preferably, the used water-soluble thermoplastic comprises a polyvinyl alcohol, whose molecular weight is in the range 10,000 to 100,000 gmol⁻¹, preferably from 11,000 to 90,000 gmol⁻¹, particularly preferably from 12,000 to 80,000 gmol⁻¹ and particularly from 13,000 to 70,000 gmol⁻¹.

It is further preferred when the thermoplastics are used in amounts of at least 50 wt. %, preferably at least 70 wt. %, particularly preferably at least 80 wt. % and particularly at least 90 wt. %, each based on the weight of the water-soluble thermoplastic polymer.

It is advantageous when the melt flow index of the thermoplastic polymer on extrusion in the first step, measured under a load of 10 kg, is between 1 and 30, preferably between 5 and 15, particularly preferably between 8 and 12 and/or the melt flow index (MFI) of the blow molding compound, measured under a load of 2.16 kg, is between 4 and 40, preferably between 5 and 20, particularly preferably between 8 and 15. In the context of the present invention, polyvinyl alcohol types that are particularly suitable for blow molding are of medium to high viscosity with, for example, MFI values of 6-8 (at 230° C., 2.16 kg load, PVA blend Vinex 2034 or 2144 manufactured by Texas Polymers) or 9-11 (at 190° C., 10 kg load, PVA blend TP Vinex 5030).

The thermoplastic polymers can comprise plastifying auxiliaries, i.e. plasticizers, to improve their processability. This can be particularly advantageous when polyvinyl alcohol or partially hydrolyzed polyvinyl acetate was chosen as the polymeric material for the portion. In particular, glycerin, triethanolamine, ethylene glycol, propylene glycol, diethylene- or dipropylene glycol, diethanolamine and methyldiethylamine have proved themselves as plasticizers.

Advantageously, the thermoplastic polymers comprise plasticizers in amounts of at least >0 wt. %, preferably ≧10 wt. %, particularly preferably >20 wt. % and particularly ≧30 wt. %, each based on the weight of the blow molding compound.

The flexible, preferably elastic, water-soluble portion can possess parts of flanges and be optionally linked and/or sealed with at least one further cavity by positive fitting and/or material bonding, preferably by welding.

The inventive portion is particularly preferably transparent and/or translucent.

Preferably, the inventive portion does not have any seam, in particular no sealed seam, no compression weld and/or no groove, particularly flange groove.

In a particular embodiment of the invention, it is also possible that the walls of the flexible, preferably elastic hollow articles that comprise the detergent, cleansing composition or care product portions consist of different materials, thus a heterogeneous structure. For example, in a polymer that forms the wall of the hollow article, could be dispersed islands of an insoluble foreign material, made, for example, of another polymer (with different water-solubility) or even made of a completely different substance (for example, an inorganic or organic substance). Examples are water-soluble salts such as, for example, sodium sulfate, sodium chloride, sodium carbonate, calcium carbonate, etc.; organic acids such as, for example, citric acid, tartaric acid, adipic acid, phthalic acid etc.; sugars like maltoses, dextroses, sorbitol etc.; zeolites; silicates; crosslinked, for example, weakly crosslinked polymers such as, for example, polyacrylates, cellulose esters, cellulose ethers like carboxymethyl cellulose. In particularly preferred embodiments of the invention, such a structure can be advantageous in that the other substance dissolves faster in water than the polymer, thus allowing water to infiltrate the hollow article and thereby contributing to accelerate the release of the components from the portion. In conclusion, the total dimensionally stable hollow article packaged in this way, dissolves faster than an article made of a pure polymeric material. Similarly, it is possible to form the walls of the hollow article from layers of two or more polymers, which in particularly preferred embodiments can be chosen such that the hollow articles are optimized in regard to their properties (stability, heat resistance, water-solubility, gas barrier properties etc.).

In a further, similarly preferred embodiment, it is of advantage according to the invention when the flexible, preferably elastic hollow body or bodies comprise(s) one or more materials from the group of acrylic acid-containing polymers, polyacrylamides, oxazoline polymers, polystyrene sulfonates, polyurethanes, polyesters and polyethers and their mixtures.

It is particularly advantageous to cite one or more material(s) from the following exemplary but non-limiting list:
mixtures of 50 to 100% polyvinyl alcohol or poly(vinyl alcohol-co-vinyl acetate) with molecular weights in the range 10,000 to 200,000 g/mol and acetate contents of 0 to 30 mol %; they can comprise processing additives such as plasticizers (glycerin, sorbitol, water, PEG etc.), lubricants (stearic acid and other mono-, di- and tricarboxylic acids), slip agents (e.g. aerosil), organic and inorganic pigments, salts, blowing agents (citric acid-sodium bicarbonate mixtures);
acrylic acid-containing polymers, such as e.g. copolymers, terpolymers or tetrapolymers that comprise at least 20% acrylic acid and have a molecular weight of 5,000 to 500,000 g/mol; the particularly preferred comonomers are esters of acrylic acid like ethyl acrylate, methyl acrylate, hydroxyethyl acrylate, ethylhexyl acrylate, butyl acrylate, and salts of acrylic acid such as sodium acrylate, methacrylic acid and its salts and its esters such as methyl methacrylate, ethyl methacrylate, trimethyl ammonium methyl methacrylate chloride (TMAEMC), methacrylatoamidopropyl trimethyl ammonium chloride (MAPTAC). Further monomers such as acrylamide, styrene, vinyl acetate, maleic anhydride, vinyl pyrrolidone can also be used with advantage;
polyalkylene oxides, preferably polyethylene oxides with molecular weights of 600 to 100,000 g/mol and their derivatives resulting from graft copolymerization with monomers such as vinyl acetate, acrylic acid and its salts and esters, methacrylic acid and its salts and esters, acrylamide, styrene, styrene sulfonate and vinyl pyrrolidone (example: poly(ethylene glycol - graft - vinyl acetate). The polyglycol fraction should be 5 to 100 wt. %, the grafted fraction should be 0 to 95 wt. %; the latter can consist of one or more monomers. A grafted fraction of 5 to 70 wt. % is particularly preferred; the water-solubility decreases with the grafted fraction;
polyvinyl pyrrolidone (PVP) with a molecular weight of 2,500 to 750,000 g/mol;
polyacrylamide with a molecular weight of 5,000 to 5,000,000 g/mol;
polyethyl oxazoline and polymethyl oxazoline with a molecular weight of 5,000 to 100,000 g/mol;
polystyrene sulfonates and their copolymers with comonomers like ethyl (meth)acrylate, methyl (meth)acrylate, hydroxyethyl (meth)acrylate, ethylhexyl (meth)acrylate, butyl (meth)acrylate and the salts of (meth)acrylic acid such as sodium (meth)acrylate, acrylamide, styrene, vinyl acetate, maleic anhydride, vinyl pyrrolidone; the comonomer content should be 0 to 80 mol % and the molecular weight should be in the range of 5,000 to 500,000 g/mol.
polyurethanes, particularly the reaction products of diisocyanates (e.g. TMXDI) with polyalkylene glycols, particularly polyethylene glycols of molecular weight 200 to 35,000, or with other difunctional alcohols to products with molecular weights of 2,000 to 100,000 g/mol.
polyesters with molecular weights of 4,000 to 100,000 g/mol, based on dicarboxylic acids (e.g. terephthalic acid, isophthalic acid, phthalic acid, sulfoisophthalic acid, oxalic acid, succinic acid, sulfosuccinic acid, glutaric acid, adipic acid, sebacic acid etc.) and diols (e.g. polyethylene glycols, for example, with molecular weights of 200 to 35,000 g/mol);
cellulose ethers/esters, e.g. cellulose acetate, cellulose butyrate, methyl cellulose, hydroxypropyl cellulose, hydroxyethyl cellulose, methylhydroxypropyl cellulose etc.;
polyvinyl methyl ethers with molecular weights of 5,000 to 500,000 g/mol.

1. A bleaching agent-containing, liquid detergent or cleansing composition comprising a liquid phase and a particulate peroxycarboxylic acid, wherein the composition comprises equal to or less than 10 wt. % water and a lamellar liquid crystalline phase which is present as long as no additional water is added.

2. The composition of claim 1, wherein the liquid phase comprises from 20 wt. % to 50 wt. % ether sulfate, from 20 wt. % to 50 wt. % of a hydrocarbon that is liquid at room temperature, up to 50 wt. % C₁₂-C₁₈ fatty alcohol, and from 1. wt. % to 10 wt. % water.

3. The composition of claim 1, wherein the peroxycarboxylic acid is in finely divided particulate form having average diameter below 100 μm.

4. The composition of claim 1, wherein the peroxycarboxylic acid has a solubility in water between 50 and 800 ppm.

5. A process for making a water-soluble portion comprising a composition of claim 1 comprising the steps of:

6. Water-soluble portion, comprising a composition according to one of claims 1 to 5, manufactured according to a process including the steps:
a) providing at least one cavity;
b) inserting a water-soluble thermoplastic polymer into the cavity;
c) adding a liquid composition to the cavity from step b) and
d) sealing the portion resulting from the steps (a) to (c).

7. The portion of claim 6, comprising a water-soluble sheath of a material from the group comprising polyvinyl alcohol (PVA), acetalized polyvinyl alcohol, polyvinyl pyrrolidone, polyethylene oxide, cellulose, starch and derivatives of these substances.
